(19) United States
(12) Patent Application Publication
(10) Pub. No.: US 2019/0144649 A1
(43) Pub. Date: May 16, 2019

(54) BARRIER FILM FOR FOOD PACKAGING

(71) Applicant: NOVA Chemicals (International) S.A., Fribourg (CH)

(72) Inventors: Patrick Lam, Calgary (CA); Monika Kleczek, Calgary (CA); Eric Vignola, Airdrie (CA)

(73) Assignee: NOVA Chemicals (International) S.A., Fribourg (CH)

(21) Appl. No.: 15/812,038

(22) Filed: Nov. 14, 2017

(51) Int. Cl. C08L 23/06; C08J 5/18; B65B 9/00; B65D 65/40

(52) U.S. Cl. CPC C08L 23/06; C08J 5/18; B65B 9/00; B65D 65/40; C08L 2201/14; C08J 2423/06; C08L 2205/025; C08L 2205/24; C08L 2207/062; C08J 2323/06; C08L 2203/16

(57) ABSTRACT

This invention relates to barrier films which are prepared from a blend of at least two high density polyethylene (hdpe) resins and a nucleating agent. The films are used to prepare packaging for dry foods such as crackers and breakfast cereals.

### FIELD OF THE INVENTION

This invention relates to barrier films which are prepared from a blend of at least two high density polyethylene (hdpe) resins and a nucleating agent. The films are used to prepare packaging for dry foods such as crackers and breakfast cereals.

### BACKGROUND OF THE INVENTION

Polyethylene may be classified into two broad families, namely “random” (which is commercially prepared by initiation with free radicals under polymerization conditions that are characterized by the use of very high ethylene pressures) and “linear” (which is commercially prepared with a transition metal catalyst, such as a “Ziegler Natta” catalyst, or a “chromium” catalyst, or a single site catalyst or a “metallocene catalyst”).

Most “random” polyethylene which is commercially sold is a homopolymer polyethylene. This type of polyethylene is also known as “high pressure low density polyethylene” because the random polymer structure produces a lower polymer density. In contrast, most “linear” polyethylene which is commercially sold is copolymer of ethylene with at least one alpha olefin (especially butene, hexene or octene). The incorporation of a comonomer into linear polyethylene reduces the density of the resulting copolymer. For example, a linear ethylene homopolymer generally has a very high density (typically greater than 0.955 grams per cubic centimeter (g/cc))—but the incorporation of small amounts of comonomer results in the production of so-called “high density polyethylene” (or “hdpe”—typically, having densities greater than 0.935 g/cc) and the incorporation of further comonomer produces so-called “linear low density polyethylene” (or “lldpe”—typically having a density of from about 0.905 g/cc to 0.935 g/cc).

Some plastic film is made from hdpe. One particular type of hdpe film is used to prepare food packaging with “barrier properties”—i.e., the film acts as a “barrier” to water vapor transmission. This so-called “barrier film” is used to prepare packages (or liners for cardboard packages) for breakfast cereals, crackers and other dry foodstuffs.

It has recently been discovered that the barrier properties of hdpe film may be improved by the addition of a nucleating agent.

We have now discovered that further improvements in barrier properties may be achieved by the use of a blend of two hdpe resins which have substantially a different melt index from each other.

### SUMMARY OF THE INVENTION

The present invention discloses a method for improving the barrier properties of a polyethylene film, said method comprising the steps of: converting into a film a mixture comprising: a) a first high density polyethylene having a density of from 0.950 to 0.975 g/cc and a high melt index I₂; b) a second high density polyethylene having a density of from 0.955 to 0.965 g/cc and a low melt index I₂, and; c) from 100 to 3,000 ppm of a calcium salt of 1,2-cyclohexane-dicarboxylic acid: wherein, the I₂ ratio, obtained by dividing said high melt index I₂ value by said low melt index I₂ value, is greater than 10/1 and said film has from about 20% to about 61% improved water vapor transmission rate compared with a control film which is made using the same amounts of said first and said second high density polyethylenes but does not contain said calcium salt of 1,2-cyclohexanedicarboxylic acid.

### DETAILED DESCRIPTION OF PREFERRED EMBODIMENTS

### Barrier Film and Food Packaging

Plastic films are widely used as packaging materials for foods. Flexible films, including multilayer films, are used to prepare bags, wrappers, pouches and other thermoformed materials.

The permeability of these plastic films to gases (especially oxygen) and moisture is an important consideration during the design of a suitable food package.

Films prepared from thermoplastic ethylene-vinyl alcohol (“EVOH”) copolymers are commonly employed as an oxygen barrier and/or for resistance to oils. However, EVOH films are quite permeable to moisture.

Conversely, polyolefins, especially high density polyethylene, are resistant to moisture transmission but comparatively permeable to oxygen.

The permeability of linear polyethylene film to moisture is typically described by a “water vapor transmission rate” (or “WVTR”). In certain applications some vapor transmission is desirable—for example, to allow moisture out of a package which contains produce. The use of linear low density polyethylene (lldpe) which may be filled with calcium carbonate (to further increase vapor transmission) is common for this purpose.

Conversely, for packages which contain crispy foods such as breakfast cereals or crackers, it is desirable to limit WVTR to very low levels to prevent the food from going stale. The use of hdpe to prepare “barrier film” is common for this purpose. A review of plastic films and WVTR behavior is provided in U.S. Pat. No. 6,777,520 (McLeod et al.)

This invention relates to “barrier films” prepared from hdpe—i.e., films with low MVTR. As will be appreciated from the above description of EVOH films, it is also known to prepare multilayer barrier films to produce a structure which is resistant to moisture and oxygen. Multilayer structures may also contain additional layers to enhance packaging quality—for example, additional layers may be included to provide impact resistance or sealability. It will also be appreciated by those skilled in the art that “tie layers” may be used to improve the adhesion between “structural” layers. In such multilayer structures, the hdpe barrier layer may either be used as an internal (“core”) layer or external (“skin”) layer.

The manufacture of “barrier” food packaging from plastic resins involves two basic operations.

The first operation involves the manufacture of plastic film from the plastic resin. Most “barrier films” are prepared by “blown film” extrusion, in which the plastic is melted in an extruder, then forced through an annular die. The extrudate from the annular die is subjected to blown air, thus forming a plastic bubble. The use of multiple extruders and concentric dies permits multilayer structures to be co-extruded by the blown film process. The “product” from this operation is “barrier film” which is collected on rolls and shipped to the manufacturers of food packaging.

The manufacturer of the food packaging generally converts the rolls of blown film into packaged foods. This typically involves three basic steps:

1) forming the package;

2) filling the package;

3) sealing the food in the finished package.

Although the specific details will vary from manufacturer to manufacturer, it will be readily appreciated that the film needs to have a balance of physical properties in order to be suitable for food packaging. In addition to low MVTR, it is desirable for the film to “seal” well and to have sufficient impact strength and stiffness (or film “modulus”) to allow easy handling of the package. Multilayer coextrusions are often used to achieve this balance of properties, with 3 and 5 layer coextrusions being well known. Sealant layers may be prepared with ethylene—vinyl acetate (EVA) ionomers (such as those sold under the trademark SURLYN™ by E.I. DuPont), very low density polyethylene (polyethylene copolymers having a density of less than 0.910 grams per cubic centimeter) and blends with small amounts of polybutene. It is known to use sealant compositions in both “skin” layers of a coextrusion or in only one of the skin layers.

### HDPE Blend Components and Overall Composition

The plastic used in the barrier film of this invention is high density polyethylene (hdpe). Specifically, the hdpe must have a density of at least 0.950 grams per cubic centimeter (“g/cc”) as determined by ASTM D 1505. Preferred hdpe has a density of greater than 0.955 g/cc and the most preferred hdpe is a homopolymer of ethylene.

### Blend Components

Blend Component a)

Blend component a) of the polyethylene composition used in this invention comprises an hdpe with a comparatively high melt index. As used herein, the term “melt index” is meant to refer to the value obtained by ASTM D 1238 (when conducted at 190° C., using a 2.16 kg weight). This term is also referenced to herein as “I₂” (expressed in grams of polyethylene which flow during the 10 minute testing period, or “gram/10 minutes”). As will be recognized by those skilled in the art, melt index, I₂, is, in general, inversely proportional to molecular weight. Thus, blend component a) of this invention has a comparatively high melt index (or, alternatively stated, a comparatively low molecular weight) in comparison to blend component b).

The absolute value of I₂ for blend component a) is preferably greater than 5 grams/10 minutes. However, the “relative value” of I₂ for blend component a) is critical—it must be at least 10 times higher than the I₂ value for blend component b) [which I₂ value for blend component b) is referred to herein as I₂′]. Thus, for the purpose of illustration: if the I₂′ value of blend component b) is 1 gram/10 minutes, then the I₂ value of blend component a) must be at least 10 grams/10 minutes.

Blend component a) is further characterized by:

i) density—it must have a density of from 0.950 to 0.975 g/cc; and

ii) weight % of the overall polyethylene composition—it must be present in an amount of from 5 to 60 weight % of the total hdpe composition (with blend component b) forming the balance of the total polyethylene) with amounts of from 10 to 50 weight %, especially from 20 to 50 weight %, being preferred. It is permissible to use more than one high density polyethylene to form blend component a).

The molecular weight distribution [which is determined by dividing the weight average molecular weight (Mw) by number average molecular weight (Mn) where Mw and Mn are determined by gel permeation chromatography, according to ASTM D 6474-99] of component a) is preferably from 2 to 20, especially from 2 to 4. While not wishing to be bound by theory, it is believed that a low Mw/Mn value (from 2 to 4) for component a) may improve the nucleation rate and overall barrier performance of blown films prepared according to the process of this invention.

### Blend Component b)

Blend component b) is also a high density polyethylene which has a density of from 0.950 to 0.970 g/cc (preferably from 0.955 to 0.965 g/cc).

The melt index of blend component b) is also determined by ASTM D 1238 at 190° C. using a 2.16 kg load. The melt index value for blend component b) (referred to herein as I₂′) is lower than that of blend component a), indicating that blend component b) has a comparatively higher molecular weight. The absolute value of I₂′ is preferably from 0.1 to 2 grams/10 minutes.

The molecular weight distribution (Mw/Mn) of component b) is not critical to the success of this invention, though a Mw/Mn of from 2 to 4 is preferred for component b).

As noted above, the ratio of the melt index of component b) divided by the melt index of component a) much be greater than 10/1.

Blend component b) may also contain more than one hdpe resin.

### Overall HDPE Composition

The overall high density blend composition used in this invention is formed by blending together blend component a) with blend component b). This overall hdpe composition must have a melt index (ASTM D 1238, measured at 190° C. with a 2.16 kg load) of from 0.5 to 10 grams/10 minutes (preferably from 0.8 to 8 grams/10 minutes).

The blends may be made by any blending process, such as: 1) physical blending of particulate resin; 2) co-feed of different hdpe resins to a common extruder; 3) melt mixing (in any conventional polymer mixing apparatus); 4) solution blending; or, 5) a polymerization process which employs 2 or more reactors.

One preferred hdpe blend composition is prepared by melt blending the following two blend components in an extruder: from 10 to 30 weight % of component a): where component a) is a conventional hdpe resin having a melt index, I₂, of from 15-30 grams/10 minutes and a density of from 0.950 to 0.960 g/cc; and from 90 to 70 weight % of component b): where component b) is a conventional hdpe resin having a melt index, I₂, of from 0.8 to 2 grams/10 minutes and a density of from 0.955 to 0.965 g/cc.

An example of a commercially available hdpe resin which is suitable for component a) is sold under the trademark SCLAIR™ 79F, which is an hdpe resin that is prepared by the homopolymerization of ethylene with a conventional Ziegler Natta catalyst. It has a typical melt index of 18 grams/10 minutes and a typical density of 0.963 g/cc and a typical molecular weight distribution of about 2.7.

Examples of commercially available hdpe resins which are suitable for blend component b) include (with typical melt index and density values shown in brackets):
SCLAIR™ 19G (melt index=1.2 grams/10 minutes, density=0.962 g/cc);
MARFLEX™ 9659 (available from Chevron Phillips, melt index=1 grams/10 minutes, density=0.962 g/cc); and
ALATHON™ L 5885 (available from Equistar, melt index=0.9 grams/10 minutes, density=0.958 g/cc).

A highly preferred hdpe blend composition is prepared by a solution polymerization process using two reactors that operate under different polymerization conditions. This provides a uniform, in situ blend of the hdpe blend components. An example of this process is described in published U.S. Patent Application Publication No. 2006/0047078 (Swabey et al.), the disclosure of which is incorporated herein by reference. The overall hdpe blend composition preferably has a MWD (Mw/Mn) of from 3 to 20.

### Nucleating Agents

The term “nucleating agent”, as used herein, is meant to convey its conventional meaning to those skilled in the art of preparing nucleated polyolefin compositions, namely, an additive that changes the crystallization behavior of a polymer as the polymer melt is cooled.

Nucleating agents are widely used to prepare classified polypropylene and to improve the molding characteristics of polyethylene terephthalate (PET).

A review of nucleating agents is provided in U.S. Pat. Nos. 5,981,636; 6,466,551 and 6,559,971, the disclosures of which are incorporated herein by reference.

There are two major families of nucleating agents, namely “inorganic” (e.g., small particulates, especially talc or calcium carbonate) and “organic”.

Examples of conventional organic nucleating agents which are commercially available and in widespread use as polypropylene additives are the dibenzylidene sorbital esters (such as the products sold under the trademark Millad™ 3988 by Milliken Chemical and Irgaclear™ by Ciba Specialty Chemicals). The present invention does not utilize either of the above described “inorganic” or conventional organic nucleating agents because they do not always improve the barrier performance of films prepared from hdpe resins (as shown in the Examples). The nucleating agents which are used in the present invention are generally referred to as “high performance nucleating agents” in literature relating to polypropylene. These nucleating agents are referred to herein as “organic barrier nucleating agents”—which, (as used herein), is meant to describe an organic nucleating agent which improves (reduces) the moisture vapor transmission rate (MVTR) of a film prepared from hdpe. This may be readily determined by: 1) preparing an hdpe film having a thickness of 1.5 to 2 mils in a conventional blown film process (as described in the Examples below) in the absence of a nucleator; 2) preparing a second film of the same thickness (with 1000 parts per million by weight of the organic nucleator being well dispersed in the hdpe) under the same conditions used to prepare the first film. If the MVTR of the second film is lower than that of the first (preferably, at least 5 to 10% lower), then the nucleator is suitable for use in the present invention.

High performance, organic nucleating agents which have a very high melting point have recently been developed. These nucleating agents are sometimes referred to as “insoluble organic” nucleating agents—to generally indicate that they do not melt disperse in polyethylene during polyolefin extrusion operations. In general, these insoluble organic nucleating agents either do not have a true melting point (i.e., they decompose prior to melting) or have a melting point greater than 300° C. or, alternatively stated, a melting/decomposition temperature of greater than 300° C.

The organic nucleating agents are preferably well dispersed in the hdpe polyethylene composition of this invention. The amount of nucleating agent used is comparatively small—from 100 to 3000 parts by million per weight (based on the weight of the polyethylene) so it will be appreciated by those skilled in the art that some care must be taken to ensure that the nucleating agent is well dispersed. It is preferred to add the nucleating agent in finely divided form (less than 50 microns, especially less than 10 microns) to the polyethylene to facilitate mixing. This type of “physical blend” (i.e., a mixture of the nucleating agent and the resin in solid form) is generally preferable to the use of a “masterbatch” of the nucleator (where the term “masterbatch” refers to the practice of first melt mixing the additive—the nucleator, in this case—with a small amount of hdpe resin—then melt mixing the “masterbatch” with the remaining bulk of the hdpe resin).

Examples of high performance organic nucleating agents which may be suitable for use in the present invention include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al. to Milliken); the salts of certain cyclic dicarboxylic acids having a hexahydrophtalic acid structure (or “HHPA” structure) as disclosed in U.S. Pat. No. 6,559,971 (Dotson et al., to Milliken); and phosphate esters, such as those disclosed in U.S. Pat. No. 5,342,868 and those sold under the trade names NA-11 and NA-21 by Asahi Denka Kogyo. Preferred nucleators are cylic dicarboxylates and the salts thereof, especially the divalent metal or metalloid salts, (particularly, calcium salts) of the HHPA structures disclosed in U.S. Pat. No. 6,559,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,559,971. A preferred example is 1,2-cyclohexanedicarboxylic acid, calcium salt (CAS registry number 491589-22-1).

### Other Additives

The hdpe may also contain other conventional additives, especially (1) primary antioxidants (such as hindered phenols, including vitamin E); (2) secondary antioxidants (especially phosphites and phosphonites); and (3) process aids (especially fluoroelastomer and/or polyethylene glycol bound process aid).

### Film Extrusion Process

Blown Film Process

The extrusion-blown film process is a well-known process for the preparation of plastic film. The process employs an extruder which heats, melts and conveys the molten plastic and forces it through an annular die. Typical extrusion temperatures are from 330 to 500° F., especially 350 to 460° F.

The polyethylene film is drawn from the die and formed into a tube shape and eventually passed through a pair of draw or nip rollers. Internal compressed air is then introduced from the mandrel causing the tube to increase in diameter forming a “bubble” of the desired size. Thus, the blown film is stretched in two directions, namely in the axial direction (by the use of forced air which “blows out” the diameter of the bubble) and in the lengthwise direction of the bubble (by the action of a winding element which pulls the bubble through the machinery). External air is also introduced around the bubble circumference to cool the melt as it exits the die. Film width is varied by introducing more or less internal air into the bubble thus increasing or decreasing the bubble size. Film thickness is controlled primarily by increasing or decreasing the speed of the draw roll or nip roll to control the draw-down rate.

The bubble is then collapsed into two doubled layers of film immediately after passing through the draw or nip rolls. The cooled film can then be processed further by cutting or sealing to produce a variety of consumer products. While not wishing to be bound by theory, it is generally believed by those skilled in the art of manufacturing blown films that the physical properties of the finished films are influenced by both the molecular structure of the polyethylene and by the processing conditions. For example, the processing conditions are thought to influence the degree of molecular orientation (in both the machine direction and the axial or cross direction).

A balance of “machine direction” (“MD”) and “transverse direction” (“TD”-which is perpendicular to MD) molecular orientation is generally considered most desirable for key properties associated with the invention (for example, Dart Impact strength, Machine Direction and Transverse Direction tear properties).

Thus, it is recognized that these stretching forces on the “bubble” can affect the physical properties of the finished film. In particular, it is known that the “blow up ratio” (i.e., the ratio of the diameter of the blown bubble to the diameter of the annular die) can have a significant effect upon the dart impact strength and tear strength of the finished film.

The above description relates to the preparation of monolayer films. Multilayer films may be prepared by 1) a “co-extrusion” process that allows more than one stream of molten polymer to be introduced to an annular die resulting in a multi-layered film membrane or 2) a lamination process in which film layers are laminated together. The films of this invention are preferably prepared using the above described blown film process.

An alternative process is the so-called cast film process, wherein the polyethylene is melted in an extruder, then forced through a linear slit die, thereby “casting” a thin flat film. The extrusion temperature for cast film is typically somewhat hotter than that used in the blown film process (with typically operating temperatures of from 450 to 550° F.). In general, cast film is cooled (quenched) more rapidly than blown film.

Further details are provided in the following examples.

### EXAMPLES

### Example 1

Screening tests for the efficiency of a high efficiency organic nucleating agent in different hdpe barrier film compositions were conducted on a blown film line manufactured by Battenfeld Gloucester Engineering Company of Gloucester, Mass. This blown film line has a standard output of more than 100 pounds per hour and is equipped with a 50 horsepower motor. The extender screw has a 2.5 mil diameter and a length/diameter (L/D) ratio of 24/1.

The blown film bubble is air cooled. Typical blow up ratio (BUR) for barrier films prepared on this line are from 1.5/1 to 4/1. An annular die having a gap of 85 mils was used for these experiments.

The films of this example were prepared using a BUR aiming point of 2/1 and a film thickness aiming point of 1.5 mils.

The “high efficiency” nucleating agent used in this example was a salt of a cyclic dicarboxylic acid, namely the calcium salt of 1,2-cyclohexanedicarboxylic acid (CAS Registry number 491589-22-1, referred to in these examples as “nucleating agent 1”).

Water Vapor Transmission Rate (“WVTR”, expressed as grams of water vapor transmitted per 100 square inches of film per day at a specified film thickness (mils), or g/100 in²/day) was measured in accordance with ASTM F1249-90 with a MOCON permatron developed by Modern Controls Inc. at conditions of 100° F. (37.8° C.) and 100% relative humidity. A control (comparative) experiment was conducted using a single low melt index hdpe resin having a melt index of about 1.2 grams/10 minutes, a density of 0.962 g/cc and a molecular weight distribution, Mw/Mn, of 4.9 (an ethylene homopolymer, sold under the trademark SCLAIR™ 19G (“19G resin”) by NOVA Chemicals Inc. (“NCI”) of Pittsburgh, Pa.).

Table 1 illustrates that a film prepared from the 19G resin in the absence of the nucleator had an MVTR value of 0.2084 g/100 in²/day (film 1) and that the nucleating agent improved the MVTR to 0.1906 g/100 in²/day (film 2). This illustrates that nucleating agent 1 is an “organic barrier nucleating agent” that may be used to improve the MVTR performance of barrier film.

Films 3 to 6 were prepared by blending 85 weight % of the 19G with 15% of resins having a high melt index, in the presence and absence of the nucleating agent 1.

Comparative films 3 and 4 were prepared using a hdpe homopolymer resin sold under the trademark SCLAIR™ 2907 as a (comparative) component b). This resin has a melt index of only 4.9 grams/10 minutes (and, accordingly, the melt index ratio of the two hdpe resins is only 4.2/1.2, or less than 4/1). The density of 2907 resin is typically 0.960 g/cc. As shown in Table 1, a film prepared with this blend in the absence of a nucleating agent had an MVTR of 0.1851 g/100 in²/day (comparative film 3) and the nucleating agent improved this value to 0.1720 g/100 in²/day—an improvement of only 0.0131 g/100 in²/day.

Inventive film 6 and comparative film 5 were prepared using an hdpe composition prepared by melt blending 85 weight % of the 19G resin with 15 weight % of an hdpe homopolymer resin sold under the trademark SCLAIR™ 79F by NCI as component b). This 79F resin had a melt index of 18 grams/10 minutes, a density of 0.963 g/cc and a molecular weight distribution of 2.7. The overall melt index (I₂) of the blend was estimated to be 1.8 grams/10 minutes.

As shown in Table 1, comparative film 5 (prepared from the 85/15 blend of the 19G and 79F hdpe resins, in the absence of nucleating agent 1) had an MVTR value of 0.1955 g/100 in²/day.

Inventive film 6, prepared from the hdpe composition of film 5 plus 1000 ppm of the nucleating agent, had an MVTR value of 0.1525 g/100 in²/day (which represents an improvement of more than 20% over the MVTR value of film 5).

Table 1 also illustrates data which describe the properties of barrier film prepared from an experimental hdpe homopolymer resin. This experimental resin was prepared in a dual reactor solution polymerization process in accordance with the disclosure of published U.S. Patent Application Publication No. 20060047078 (Swabey et al.). The experimental resin (EXP in Table 1) had a melt index, I₂, of 1.2 grams/10 minutes, a density of 0.967 g/cc and a molecular weight distribution, Mw/Mn, of 8.9. The EXP resin had two distinct fractions which varied according to molecular weight. The low molecular weight fraction (or component a)) was about 55 weight % of the total composition and had a melt index, I₂, which was estimated to be greater than 5000 grams/10 minutes. The high molecular weight fraction was about 45 weight % of the total composition and had a melt index which was estimated to be less than 0.1 grams/10 minutes.

As noted above, melt index (I₂) is generally inversely proportional to molecular weight for polyethylene resins. This was confirmed for homopolymer hdpe resins having a narrow molecular weight distribution (of less than 3) by preparing a plot of log (I₂) versus log (weight average molecular weight, Mw). In order to prepare this plot, the melt index (I₂) and weight average molecular Mw) of more than 15 different homopolymer hdpe resins was measured. These homopolymer hdpe resins had a narrow molecular weight distribution (less than 3) but had different Mw—ranging from about 30,000 to 150,000. (As will be appreciated by those skilled in the art, it is difficult to obtain reproducible I₂ values for polyethylene resins having a molecular weight which is outside of this range).

A log/log plot of these I₂ and Mw values was used to calculate the following relation between I₂ and Mw for such homopolymer hdpe resins:

I₂=(1.774×10¹⁹)×(Mw^{-3.86}).

Extrapolation (based on the above relation) was used to estimate the 12 values of component a) and component b) of the EXP resin. That is, the molecular weight of component a) and component b) was measured and the Mw values were used to estimate the I₂ values. It will be appreciated by those skilled in the art that it can be difficult to physically blend these hdpe blend components (due to the very different viscosities of these hdpe blend components). Accordingly, solution blending or an in-situ blending (i.e., prepared by a polymerization process) are preferred methods to prepare such hdpe compositions. As shown in Table 1, (comparative) film 7, prepared from this EXP resin had an MVTR of 0.1594 grams/10 minutes. Inventive film 8 was made with an hdpe composition prepared by adding 1000 ppm of the nucleating agent to the EXP resin.

### Example 2—Comparative

Barrier films were prepared with the inventive hdpe blend compositions used in experiment 6 of Example 1 (i.e. 85/15 of the afore-described 19G and 79F resins) with other nucleating agents.

The films were prepared on a smaller film line manufactured by Macro Engineering and Technology of Mississauga, Ontario, Canada. The line was operated with an annular die having a die gap of 100 mls; a BUR aiming point of 2:1 and a film thickness aiming point of 1.5 mils.

The data in Table 2 illustrate that neither talc nor DBS are suitable for use in this invention.

TABLE 1

| | HDPE Composition | | | Nucleating | WVTR |
|---|---|---|---|---|---|
| | | Component a) | Component b) | Agent 1 | (g/100 |
| Film | | (wt %) | (wt %) | (ppm) | in²/day) |
| 1-c | | — | “19G (100%)” | — | 0.2084 |
| 2-c | | — | “19G (100%)” | 1000 | 0.1906 |
| 3-c | | 2907 (15%) | “19G (85%)” | — | 0.1851 |
| 4-c | | 2907 (15%) | “19G (85%)” | 1000 | 0.1720 |
| 5-c | | 79F (15%) | “19G (85%)” | — | 0.1955 |
| 6 | | 79F (15%) | “19G (85%)” | 1000 | 0.1525 |
| 7-c | “EXP” | | | — | 0.1594 |
| 8 | “EXP” | | | 1000 | 0.0749 |

Notes:
“19G” = SCLAIR ™ 19G (I₂ = 1.2 grams/10 minutes, density = 0.962 g/cc)
“2907” = SCLAIR ™ 2907 (I₂ = 4.9 grams/10 minutes, density = 0.960 g/cc
“79F” = SCLAIR ™ 79F (I₂ = 18 grams/10 minutes, density = 0.963 g/cc)
EXP = experimental resin (described above) (I₂ = 1.2 grams/10 minutes, density = 0.967 g/cc)

TABLE 2

| | Nucleating Agent | WVTR |
|---|---|---|
| Film | (ppm) | (g/100 in²/day) |
| 10 | None | 0.2445 |
| 11 | Talc (2500 (ppm) | 0.2503 |
| 12 | DBS (ppm) | 0.3836 |
| 13 | Organic Nucleating Agent | 0.1574 |
| | (1000 ppm) | |

Notes:
Organic nucleating agent 1 was the same as used in inventive films 2, 4, 6 and 8 of example 1.
The hdpe composition used in all experiments was that of experiment 6 of example 1 (i.e. 85 weight % SCLAIR ™ 19G resin and 15 weight % SCLAIR ™ 79F resin). The “DBS” nucleating agent is a dibenzylidene sorbital ester sold under the trademark Irgaclear ™ by Ciba. The talc was sold under the trademark Cimpact ™ 699 and was reported to have an average particle size of 1.5 microns and an aspect ratio of 5:1.

### Example 3

The HDPE composition labelled “EXP” in Table 1 was observed to provide blown films having outstanding (low) WVTR.

This example illustrates the preparations of HDPE compositions that have a) a broader Mw/Mn and/or b) a different melt index, I₂, in comparison to EXP.

HDPE compositions 30-34 were prepared for this example. These compositions were prepared in a dual reactor solution polymerization process in accordance with the teachings of U.S. Pat. No. 7,737,220 (Swabey et al.). HDPE compositions 30 to 34 are homopolymers; however, copolymers containing a small amount of comonomer are also contemplated, provided that the density of the HDPE composition remains above about 0.95 g/cc. HDPE compositions 30 to 34 were prepared using a single site catalyst in both reactors of the dual reactor process and this is preferred.

As shown in Table 3, HDPE compositions 30, 31, 32 and 33 have a broader molecular weight distribution (MWD) than the EXP compositions (as indicated by Mw/Mn values of 15.2, 16.4, 19.7, and 11.7, relative to the 8.9 Mw/Mn of EXP). Increasing the breadth of the MWD was observed to improve (lower) the WVTR of films made from these compositions as shown in Table 3. The films that are reported in Table 3 were prepared on a blown film line, using BUR aim point of 2:1 and a film thickness aim point of 1.5 mils and these films contained 1200 ppm of “nucleating agent 1” (the same nucleating agent used in the preparation of Film 13).

HDPE composition 34 was also prepared in accordance with the teachings of Swabey. The melt index (I₂) of this composition was increased by lowering the molecular weight of the polymer produced in the first reactor. As shown in Table 3, it is possible to improve (lower) WVTR by increasing 12 in this manner. Film made from inventive HDPE composition 34 has outstanding WVTR and the most obvious difference between HDPE composition 34 and the EXP composition is an increase in melt index (I₂) from 1.2 to 2.2 g/10 minutes—i.e., both have a similar Mw/Mn.

The large improvement in WVTR from the small change in 12 is quite surprising. It is also a practical/useful result because HDPE composition 34 is, in general, easier to prepare in a dual reactor solution polymerization process than HDPE compositions 30 to 32 having a much broader MWD.

The data in Table 3 indicate that further improvements in WVTR may be achieved by producing a HDPE composition having both a higher melt index (greater than 2) and a broader molecular weight distribution (Mw/Mn of greater than 8).

As noted above, the WVTR data shown in Table 3 are for films that contain nucleating agent. Control films (without nucleating agent) were also made from compositions 32 and 33. These control films had WVTR performance of 0.162 and 0.182 g/100 in²/day (respectively). The improvement in WVTR of the film made from nucleated HDPE composition 33 is outstanding—the WVTR value of 0.0711 (g/100 in²/day) was a 61% improvement over the non-nucleated control film having a WVTR value of 0.182 (g/100 in²/day), i.e. (0.182−0.0711)+0.182×100%=61%); where the control film was of the same chemical composition, however it did not contain the nucleating agent, i.e. 1200 ppm of “nucleating agent 1”. Note: Although the aim point thickness for all films was 1.5 mils, some films were thicker (as high as 1.7 mils). WVTR values were normalized for these thicker films (i.e. adjusted by the same proportion that the film was thicker than the aim point—for example, a 1.7 mil thick film would have the WVTR value “normalized” by multiplying by 1.7/1.5).

TABLE 3

| | | Melt | | | | |
|---|---|---|---|---|---|---|
| | Density | Index I₂ | | | Mw/ | WVTR |
| HDPE | (g/cc) | (g/10 min) | Mn | Mw | Mn | (g/100 in²/day) |
| 30 | 0.966 | 1.1 | 6394 | 97410 | 15.2 | 0.0722 |
| 31 | 0.966 | 1.3 | 5967 | 97855 | 16.4 | 0.0686 |
| 32 | 0.967 | 1.3 | 5300 | 104286 | 19.7 | 0.0731 |
| 33 | 0.967 | 2.0 | 7437 | 86432 | 11.6 | 0.0711 |
| 34 | 0.967 | 2.2 | 10521 | 91284 | 8.7 | 0.0637 |

### Example 4

The previous examples illustrated that WVTR performance was improved by increasing the molecular weight distribution (Mw/Mn) and or increasing the melt index (I₂) of the HDPE compositions that were used to prepare the films.

However, it has previously been observed that HDPE compositions having a low melt index and a broad molecular weight distribution are prone to the formation of polyethylene “dust” during processing. The formation of “dust” (i.e., abraded polyethylene particles) during the manufacture of packages from HDPE compositions is described in U.S. Patent Application Publication No. 2006/0246309 (Marshall et al.).

As recited in Marshall et al: “The manufacture of food packages from hdpe barrier film causes the film to come in contact with various types of film production and conversion machinery. The friction which results from this contact can cause the polyethylene film to abrade, thus leaving fine particles of abraded polyethylene on the surface of the film. This condition is referred to as “dusting” because the fine hdpe particles look like dust.”

Marshall et al. teach that the addition of talc can further mitigate the dusting problem.

“Preferred talcs have a median particle size of less than 10 microns. Talc having a larger particle size is still an effective anti-dusting agent (as illustrated by the examples) but the larger sized talc particles are generally more difficult to disperse. Talc agglomerates in the barrier film may cause “gels” (which, in turn, may diminish the barrier performance and the physical properties of the film—particularly moisture barrier performance and impact strength).

The preferred concentration of talc is from 500 to 20,000 parts per million by weight (hereinafter “ppm”). Preferred concentrations are from 1,000 to 10,000 ppm. Lower concentrations may reduce the anti-dusting performance and higher concentrations become increasingly difficult to disperse—which may lead to the agglomerate/gel problem noted above.

The “aspect ratio” of various talcs has also been studied but has not been found to make a large difference in anti-dusting performance.

Whilst not wishing to be bound by theory, it is believed that the talc in the barrier film reduces the abrasive forces between the packaging machinery and the plastic film surface, thereby reducing the amount of “dust” being formed.”

“Low dusting” films were made from HDPE composition 34 (in generally the same manner as used to prepare the films of Example 3—i.e., BUR 2:1; film thickness 1.5 mils; and using 1200 ppm of nucleating agent 1). Talc was added to HDPE composition 34 to prepare compositions for the “low dusting” films (in amounts of 5000 and 10,000 ppm for films 41 and 42, respectively). These films were then subjected to a “dusting test” that is described below.

The test swatch is preferably a dark colored fabric so as to allow the “dust” accumulation to be readily observed. A fabric having a “rough” surface is also preferred. The dusting tests of this work were completed using black felt.

The machine used to move/draw the film roll for this test was an “unwind/rewind” machine of the type well known to those skilled in the art and commonly used to allow film width to be slit/cut to a desired dimension. The test swatch was mounted at a location between the rollers on the unwind/rewind machine in a manner that caused the test swatch to come into contact with the moving film.

In general, the test is undertaken by:

(1) fixing a test swatch on a stationery mount;

(2) drawing a quantity of film across the test swatch (under constant tension conditions, for a fixed period of time);

(3) observing the amount of “dust” which is deposited upon the test swatch; and (preferably)

(4) quantifying the amount of dust on the test swatch.

The black test swatch was removed at the end of each 15 minute test. A quantitative result was then obtained as follows.

A section of the test swatch was photographed with a digital camera. The resulting digital image was then analyzed to measure the percentage of the surface which was white (indicating “dust” deposits) and the percentage which remained black. At least two representative sections of each swatch were analyzed and the results are reported as dusting values (%). Thus, for clarity, film 34 shows a “whiteness rating” of I₂%—which indicates that I₂% of the swatch area was covered with white dust. Similarly, film 41 had a whiteness rating of 2%.

Results from the dusting tests are shown in Table 4.

TABLE 4

| HDPE Composition | Dusting Value (%) (1) | WVTR g/100 in²/day |
|---|---|---|
| 34 | 12 | 0.0637 |
| 41 | 2 | 0.1046 |
| 42 | 0 | 0.1107 |

(1) Lower values are desirable.

As shown in Table 4, the film made from HDPE composition 34 (without talc) had a high dusting value (I₂%). This dusting value was reduced to 2% by the addition of 5000 ppm of talc to HDPE composition 34, although the WVTR increased to 0.1046 (from 0.0637 g/100 in²/day). The dusting level was observed to be further reduced by increasing the talc load, though a further deterioration in WVTR performance was also observed (film made from HDPE composition 42).

While not wishing to be bound by theory, it is believed that the “dusting’ problem described above becomes more severe as the molecular weight distribution of the resin used to make the film increases. Accordingly, in an attempt to make a low dusting film, an HDPE composition was polymerized in the manner generally described in Swabey et al (i.e. a homopolymerization in a dual reactor, solution polymerization process, using a single site catalyst in each reactor) but conditions were adjusted to produce a homopolymer having a melt index, 12 of 1.2 g/10 minutes, an Mn of 24 thousand and a narrower Mw/Mn of 4 (“composition 50”). A film was made from this resin in the manner described above (i.e., 1200 ppm of nucleating agent 1, BUR 2:1; film thickness of 1.5 mils). The film had a WVTR of 0.0926 g/100 in²/day and a dusting value (in the absence of talc) of 15. However, the addition of 5000 ppm of talc was observed to produce a film having a dusting value of 0—though the WVTR increased to 0.1077.

This nucleated resin composition (composition 50)—which offers reasonably good WVTR and improved dusting performance—would be useful in the preparation of a multilayer film in which a resin with excellent WVTR performance (such as, HDPE composition 34) is used in the core layer and a least one skin layer is made from composition 50.

What is claimed is:

1. A method for improving the barrier properties of a polyethylene film, said method comprising the steps of: converting into a film a mixture comprising;
a) a first high density polyethylene having a density of from 0.950 to 0.975 g/cc and a high melt index I₂;
b) a second high density polyethylene having a density of from 0.955 to 0.965 g/cc and a low melt index I₂′, and;
c) from 100 to 3,000 ppm of a calcium salt of 1,2-cyclohexanedicarboxylic acid; wherein the I₂ ratio, obtained by dividing said high melt index I₂ value by said low melt index I₂′ value, is greater than 10/1;
wherein said film has from about 20% to about 61% improved water vapor transmission rate compared with a control film which is made using the same amounts of said first and said second high density polyethylenes but does not contain said calcium salt of 1,2-cyclohexanedicarboxylic acid, and;
wherein density is measured according to ASTM D 1505 and melt index is measured according to ASTM D 1238 when conducted at 190° C. using a 2.16 kg weight.

2. The method of claim 1, wherein said mixture comprises; from 5 to 60 weight % of said first high density polyethylene and from 95 to 40 weight % of said second high density polyethylene, based on the total weight of said mixture.

3. The method of claim 1, wherein said first high density polyethylene is further characterized by having a molecular weight distribution, Mw/Mn, of from 2 to 4.

4. The method of claim 1, wherein said mixture has a density from 0.955 to 0.967 g/cc.

5. The method of claim 1, wherein said mixture has a melt index, I₂, of from 0.8 to 8 grams/10 minutes.

6. The method of claim 1, wherein said mixture has a melt index, I₂, of from about 1.1 to about 2.2 grams/10 minutes.

7. The method of claim 1 wherein said mixture has a molecular weight distribution, Mw/Mn, of from about 8.7 to about 19.7.
